(19) United States
(12) Patent Application Publication
(10) Pub. No.: US 2010/0217768 A1
(43) Pub. Date: Aug. 26, 2010

(54) Query System for Biomedical Literature Using Keyword Weighted Queries

(76) Inventor: Hong Yu, Whitefish Bay, WI (US)

Correspondence Address: BOYLE FREDRICKSON S.C., 840 North Plankinton Avenue, MILWAUKEE, WI, 53203, US

(21) Appl. No.: 12/708,956

(22) Filed: Feb. 19, 2010

Related U.S. Application Data
(60) Provisional application No. 61/154,148, filed on Feb. 20, 2009.

(51) Int. Cl. G06F 17/30; G06F 15/18

(52) U.S. Cl. 707/750; 706/12; 707/E17.008; 707/E17.069

(57) ABSTRACT

An information retrieval system for biomedical information uses a supervised machine learning system to identify keywords to improve search efficiency. The supervised machine learning system may be trained using a set of clinical questions whose keywords have been extracted, for example, by trained individuals. Weighting of search terms in the document query process is based at least in part on keywords identification.

### CROSS REFERENCE TO RELATED APPLICATION

This application claims the benefit of U.S. Provisional Application No. 61/154,148 filed Feb. 20, 2009 and hereby incorporated by reference in its entirety.

### STATEMENT REGARDING FEDERALLY SPONSORED RESEARCH OR DEVELOPMENT

### BACKGROUND OF THE INVENTION

The present invention relates to computerized information retrieval systems and, in particular, to an automatic system for identifying search terms and weightings from queries.

Clinicians and biomedical researchers often need to search a vast body of literature in order to make informed decisions. Most existing information retrieval systems require the user to enter search terms which are then used to search for relevant documents. As a practical matter, clinicians and biomedical researchers often frame their information retrieval tasks as complex questions and may not have the inclination or expertise to identify the proper search terms.

It is known to assign search terms with weightings, for example, according to the “inverse document frequency” (IDF). Generally the IDF considers how common a search term is in the corpus of documents being searched, specifically:

$${idf}_{i} = log \frac{\vert D \vert}{\vert \{ d : {t}_{i} ε d \} \vert}$$

where D is the total number of documents in the body being searched, and

|{d:tᵢ ε d}| is the number of documents where the term tᵢ appears.

Uncommon terms, that thus better serve to differentiate among documents, are given greater weight.

### SUMMARY OF THE INVENTION

The present invention provides improved information retrieval by automatically identifying “keywords” in query terms provided by a user and giving the identified keywords greater weight in the search. The keywords are automatically extracted from the query words using supervised machine learning on a machine trained using a set of actual clinical questions and manually extracted keywords.

Specifically, the present invention provides an information retrieval system including a database of text documents and an electronic computer executing a stored program to receive a text query from a human operator wishing to identify documents in the database of text documents. The query is applied to a supervised machine learning system trained using a training set of training queries and associated keywords to identify keywords. A search of the database of text documents is then conducted to find documents including a set of the query words, and the found documents are given a weighting for ranking at least in part dependent on whether words from the set of query words in a given document are also keywords. A listing of found documents is then output, ranked according to their weighting. An evaluation was performed to conclude that the weighted keyword model improved information retrieval in one dataset: the Genomics TREC evaluation data collection.

It is thus a feature of at least one embodiment of the invention to provide an improved method of identifying relevant documents in a search by automatically identifying keywords and using the keywords in ranking recovered documents.

The text query may be in the form of a sentence question.

It is thus a feature of at least one embodiment of the invention to provide a system that can accept natural language queries from clinicians.

The database of text documents may be biomedical literature and the training queries may be examples of questions posed by clinicians and the keywords may be keywords identified by physicians from the questions.

It is thus a feature of at least one embodiment of the invention to provide a system uniquely adapted for managing the vast body of growing biomedical literature.

The supervised machine learning system may be a naive Bayes system, a decision tree, a neural network, or a support vector machine and may use methods of logistic regression or conditional random fields.

It is thus a feature of at least one embodiment of the invention to flexibly employ supervised machine learning systems to provide keyword identification tailored to a particular field of study through a focused training set.

The information retrieval system may include a feature extractor receiving the query and extracting for the query word features selected from the group consisting of: word position, character length, part of speech, inverse document frequency, and semantic type.

It is thus a feature of at least one embodiment of the invention to identify a set of features useful for machine extraction of keywords.

The information retrieval system may include a word list of words in the domain of biomedical literature and the weighting of the found documents may be at least in part dependent on whether words from the set of query words are found in the word list.

It is thus a feature of at least one embodiment of the invention to provide weighting based on the domain specificity of particular words.

The word lists may provide synonyms, and the step of searching the database of text documents to find documents may also search the database of text documents to find documents including synonyms of the query words.

It is thus a feature of at least one embodiment of the invention to permit query expansion within a particular field of study.

The word list may provide semantic types and the feature extractor may determine semantic type from the word list.

It is thus a feature of at least one embodiment of the invention to take advantage of the semantic type categorizations provided by word lists such as the UMLS thesaurus.

These particular objects and advantages may apply to only some embodiments falling within the claims and thus do not define the scope of the invention.

### BRIEF DESCRIPTION OF THE DRAWINGS

FIG. 1 is a simplified block diagram of an information retrieval system employing a computer terminal for receiving a query, the computer terminal communicating with a processor unit and a mass storage system holding a text database;

FIG. 2 is a process block diagram showing the principal elements of the information retrieval system of the present invention in a preferred embodiment as implemented on the processor unit of FIG. 2; and

FIG. 3 is a flow chart showing the steps of executing a query according to the keywords weighted terms identified by the system of FIG. 1.

### DETAILED DESCRIPTION OF THE PREFERRED EMBODIMENT

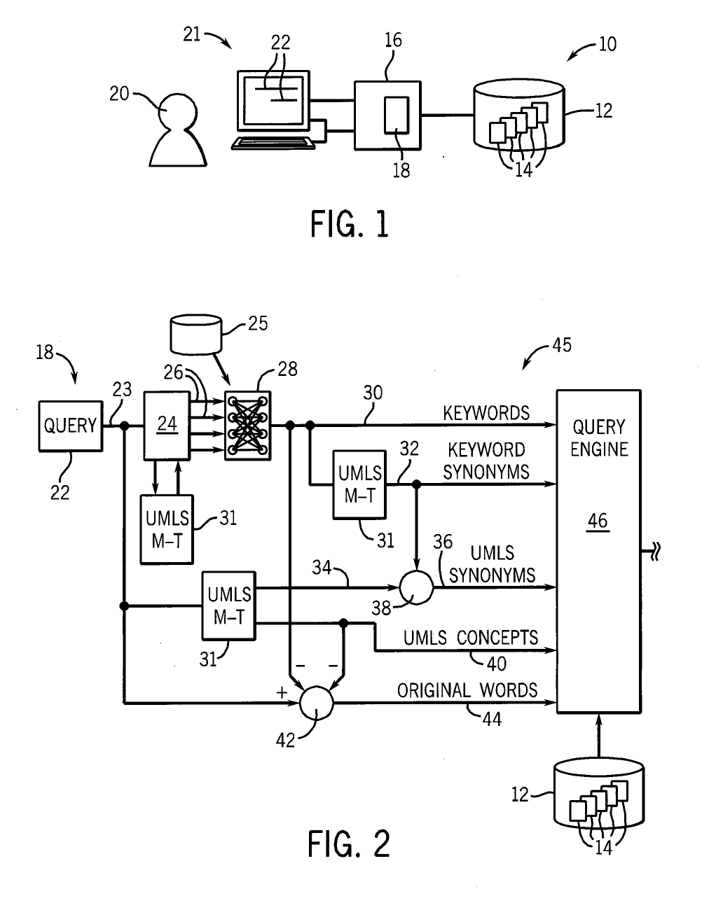

Referring now to FIG. 1, a biomedical database system 10 may include a mass storage system 12 holding multiple text documents 14, for example the text documents 14 providing peer-reviewed medical literature and the like.

The mass storage system 12 may communicate with a computer system 16, for example a single processing unit, computer or set of linked computers or processors executing a stored program 18, to implement a searching system for retrieval of particular ones of the text documents 14. The program 18 may accept as input from a user 20 a query 22 as entered on a computer terminal 21, for example, providing an electronic display keyboard or other input device.

The present invention contemplates that the query 22 may be a question of a type that may be posed by a physician, for example:

The maximum dose of estradiol valerate is 20 mg every 2 weeks. We use 25 mg every month which seems to control her hot flashes. But is that adequate for osteoporosis and cardiovascular disease prevention?

The query 22 will typically be in the form of a text string comprised of a plurality of query words 23 either in a natural language sentence or linked by Boolean or regular expression type connectors.

Referring now to FIG. 2, the query 22 received by the program 18 executing on the computer system 16 may be analyzed by a feature extractor 24 extracting quantitative features 26 from each query word 23, such features 26 that can be machine processed. As will be described below, the features 26 are provided to a supervised machine learning system 28 to identify keywords 30 from the query 22.

In a preferred embodiment, a feature extractor 24 extracts for each query word 23 of the query 22: the word position, being a count of the number of words between the given word and the beginning of the query 22; character length, being the length of the given word in characters; part of speech, being, for example, noun, verb etc.; IDF, being the inverse document frequency of the given word; and semantic type, for example, the category of the given word in a set of predetermined categories such as: physical object or concept or idea.

Specifically, the semantic type of the query word 23 may be obtained through the use of the Unified Medical Language System (UMLS) metathesaurus 31 as is sponsored by the United States National Library of Medicine (http://www.nlm.nih.gov/pubs/factsheets/umlsmeta.html). The UMLS metathesaurus 31 is a database which contains information about biomedical and health related words and provides not only a vocabulary list for more than one million biomedical concepts, but also semantic types for the words and synonyms for the words. Examples of semantic types provided by the metathesaurus 31 include:

Organisms

Anatomical structures

Biologic function

Chemicals

Events

Physical objects

Concepts or ideas.

The synonyms provided by the UMLS metathesaurus 31 may include other words or phrases as well as relevant medical codes, for example, ICD-9 codes. For example, the synonyms provided by the metathesaurus 31 for “atrial fibrillation” may include:

AF

AFib

Atrial fibrillation (disorder)

atrium; fibrillation

ICD-9-CM

NCI Thesaurus

MedDRA

SNOMED Clinical Terms

ICPC2-ICD10 Thesaurus.

The parts of speech may be obtained using the Stanford Parser sponsored by Stanford University as part of their natural language processing group (http://nlp.stanford.edu/software/lex-parser.shtml).

The features 26 from the feature extractor 24 for each word in the query 22 are then provided to a supervised machine learning system 28 which will be used to identify keywords 30 from among the words of the query 22. The supervised machine learning system 28 may be selected from a variety of such devices including naïve Bayes devices, decision tree devices, neural networks, and support vector machines (SVMs). SVM's are used in the preferred embodiment. The supervised machine learning system 28 may employ a method of logistic regression or conditional random fields or the like. In a preferred embodiment, the supervised machine learning system 28 employs the WEKA-3 system available from the University of Waikato (http://www.cs.waikato.ac.nz/ml/weka/).

The supervised machine learning system 28 must be trained through the use of a training set 25 providing example queries and correct keywords for those queries as is understood in the art. In one embodiment, the supervised machine learning system 28 is trained using approximately 4,654 clinical questions maintained by the United States National Library of Medicine (NLM). These questions were collected from healthcare providers across the United States and were assigned from one to three training keywords by physicians: 4,167 questions were assigned one training keyword, 471 questions were assigned two training keywords and fourteen questions were assigned three training keywords. For the example, for the question provided above, the training keywords assigned were: “estrogen replacement therapy”, “osteoporosis”, and “coronary arteriosclerosis”.

As will be understood to those of ordinary skill in the art, the questions of this training set are provided sequentially to the feature extractor 24 which in turn provides input to the untrained machine learning system 28. At the time of the application of each question to the feature extractor 24, the corresponding keywords of this training set are provided to the output of the machine learning system 28 so that it can “learn” rules for extracting keywords for this type of data set. In cases where the training keywords of the NLM questions were not found in the questions themselves, these keywords and their questions were omitted from the training set.

The keywords 30 identified by the supervised machine learning system 28 after training are provided to the metathesaurus 31 to obtain keyword synonyms 32. In addition, the metathesaurus 31 receives the original query words 23 to provide synonyms 34 for the query words 23. The keyword synonyms 32 already identified are then removed from the synonyms 34 as indicated schematically by junction 38 to provide UMLS synonyms 36.

The metathesaurus 31 receiving the query words 23 may also filter the query words 23 to provide UMLS concept words 40, being those query words 23 found in the vocabulary of the metathesaurus 31. In addition, the query words 23 may be processed as indicated by junction 42 to remove keywords 30 and UMLS concept words 40 to provide original words 44.

Each of the above described keywords 30, keyword synonyms 32, UMLS synonyms 36, UMLS concepts 40, and original words 44 (collectively the search words 45) are provided to the query engine 46 which may use the search words 45 for a search of the text documents 14 and assign weightings to those search words 45 based on their identification as keywords, keyword synonyms, etc. One possible weighting system used in the present invention provides the following weightings:

| Search word type | Search weighting |
|---|---|
| Original Words | 1 × IDF Value |
| UMLS Synonyms Words | 2 × IDF value |
| UMLS Concept Words | 3 × IDF Value |
| Keyword Synonyms | 4 × IDF Value |
| Keywords | 5 × IDF value. |

The query engine 46 may then communicate with the mass storage system 12 to collect text documents 14 according to the inputs and weightings.

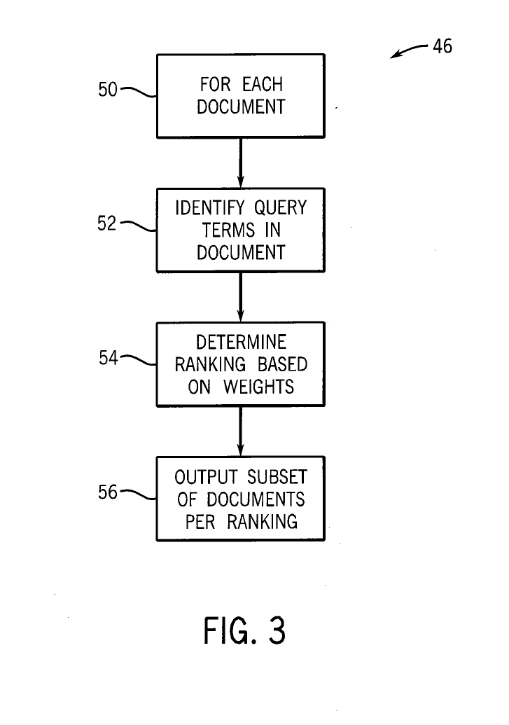

Referring now to FIG. 3, the program 18 implementing the query engine 46 logically reviews each text document 14 as indicated by process block 50. In practice, this review process may be via a pre-prepared concordance of words and locations to provide greater speed and need not require actual review of the text documents 14 during the search process.

At process block 52, the search words 45 provided to the query engine 46 are then identified in each text document 14 and those text documents 14 containing at least one of the search words are collected.

At process block 54, the collected text documents 14 from process block 52 are ranked according to a sum of the above weightings for each of the search words 45 found in the particular text documents 14.

A subset of the identified text documents 14 from process block 52 is then output as indicated by process block 56 as the search output. This subset of documents is ordered according to the ranking of process block 54 normally truncated to provide a fixed number of text documents 14 having a ranking above a predetermined value.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

1. An information retrieval system comprising:
a database of text documents;
an electronic computer executing a stored program to:
(1) receive a text query from a human operator wishing to identify documents in the database of text documents, the text query including a plurality of query words;
(2) apply the plurality of words to a supervised machine learning system trained using a training set of training queries and associated training keywords, to identify search keywords fewer in number than the plurality of query words;
(3) search the database of text documents to find documents including a set of the query words;
(4) provide a weighting to the found documents at least in part dependent on whether words from the set of query words in a given document are also search keywords; and
(5) return a listing of found documents ranked according to their weighting.

2. The information retrieval system of claim 1 wherein the text query is in the form of a sentence question.

3. The information retrieval system of claim 1 wherein the database of text documents is biomedical literature and training queries are examples of questions posed by clinicians and the training keywords are identified by physicians from the questions.

4. The information retrieval system of claim 1 wherein the supervised machine learning system is selected from the group consisting of naive Bayes, decision tree, neural networks, and support vector machines.

5. The information retrieval system of claim 1 wherein the supervised machine learning system uses a method selected from the group consisting of logistic regression and conditional random fields.

6. The information retrieval system of claim 1 further including a feature extractor receiving the query and extracting for the query words features selected from the group consisting of: word position, character length, part of speech, inverse document frequency, and semantic type.

7. The information retrieval system of claim 1 further including a word list of words in a domain of biomedical literature and where in the weighting of the found documents is at least in part dependent on whether words from the set of query words are found in the word list.

8. The information retrieval system of claim 7 wherein the word lists provide synonyms and wherein the step of searching a database of text documents to find documents including a set of query words also searches the database of text documents to find documents including synonyms of the query words.

9. The information retrieval system of claim 7 further including a feature extractor receiving the query and extracting for the query words a feature of semantic type;
and wherein the word list provides semantic types and wherein the feature extractor determines semantic type from the word list.

10. The information retrieval system of claim 7 wherein the word list is the UMLS thesaurus.

11. A method of information retrieval system for biomedical literature comprising the steps of:
(1) training a supervised machine learning system to identify ranking keywords from queries by providing a training set of questions asked by physicians and training keywords identified by physicians from those questions;
(2) receiving a text query from a human operator wishing to identify documents in the database of biomedical literature, the text query including a plurality of query words;
(3) applying the plurality of words to be trained to a supervised machine learning system to identify ranking keywords fewer in number than the plurality of query words;
(4) searching a database of text documents to find documents including a set of the query words;
(5) providing a weighting to the found documents at least in part dependent on whether words from the set of query words in a given document are also ranking keywords; and
(6) returning a listing of found documents ranked according to their weighting.

12. The method of claim 11 wherein the text query is in the form of a sentence question.

13. The method of claim 11 wherein the database of text documents are biomedical literature and training queries are examples of questions posed by clinicians and the training keywords are identified by physicians from the questions.

14. The method of claim 11 wherein the supervised machine learning system is selected from the group consisting of naïve Bayes, decision tree, neural networks, and support vector machines.

15. The method of claim 11 wherein the supervised machine learning systems use a method selected from the group consisting of logistic regression and conditional random fields.

16. The method of claim 11 further including a feature extractor receiving the query and extracting for the query word features selected from the group consisting of: word position, character length, part of speech, inverse document frequency, and semantic type.

17. The method of claim 11 further including a word list of words in a domain of biomedical literature and wherein the weighting of the found documents is at least in part dependent on whether words from the set of query words are found in the word list.

18. The method of claim 17 wherein the word lists provide synonyms and wherein the step of searching a database of text documents to find documents including a set of query words also searches the database of text documents to find documents including synonyms of the query words.

19. The method of claim 17 wherein the word list provides semantic types and where in the feature extractor determines semantic type from the word list.

20. The method of claim 17 wherein the word list is the UMLS thesaurus.
